(19) United States
(12) Patent Application Publication
(10) Pub. No.: US 2005/0247353 A1
(43) Pub. Date: Nov. 10, 2005

(54) Control valve for adjusting temperature of water

(76) Inventor: Chih-Hung Kao, Taipei (TW)

Correspondence Address: BACON & THOMAS, PLLC, 625 SLATERS LANE, FOURTH FLOOR, ALEXANDRIA, VA, 22314, US

(21) Appl. No.: 10/840,246

(22) Filed: May 7, 2004

(51) Int. Cl. F16K 11/074

(52) U.S. Cl. 137/625.41

(57) ABSTRACT

A control valve for convenient mixing of hot and cold water is disclosed. The valve has a lower tube and an upper tube is rotatably mounted outside an upper portion of the lower tube. An outlet disk is mounted in the upper tube. The outlet disk has two holes defined through the outlet disk. An adjusting disk is mounted in the lower tube and abuts a bottom of the outlet disk. The adjusting disk has an opening defined through a portion of the adjusting disk. A valve core is installed in the lower tube. The control valve can be directly installed at an outlet of a faucet or a shower. Whereby, a user can conveniently adjust a water temperature by turning the lower tube of the control valve.

### BACKGROUND OF THE INVENTION

1. Field of the Invention

The present invention relates to a control valve, and more particularly to a control valve installed in a faucet or shower for adjusting the temperature of water flowing through the faucet.

2. Description of Related Art

A conventional faucet connected with a water heater for providing hot water is generally provided with one or two control knobs for adjusting the flows of cold and hot water. The control knob(s) is installed outside the faucet and occupies a certain space. For a shower connected with a faucet, the control knob(s) is also installed adjacent to the faucet. Therefore, if a user holding the shower needs to adjust water temperature, it is necessary to move towards the faucet to operate the control knob(s), which makes using the shower inconvenient.

Therefore, the invention provides a control valve for adjusting water temperature to mitigate or obviate the aforementioned problems.

### SUMMARY OF THE INVENTION

The main objective of the present invention is to provide a control valve which is directly installed at a water outlet and is convenient to adjust water temperature.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a control valve for a shower in accordance with the present invention;

FIG. 2 is a cross sectional view of the control valve of the control valve in FIG. 1;

FIG. 3 is a top view of the control valve in a first status;

FIG. 4 is a top view of the control valve in a second status;

FIG. 5 is a schematically perspective view of the control valve assembled on a pipe; and

FIG. 6 is a cross sectional view of another embodiment of the control valve in accordance with the invention.

### DETAILED DESCRIPTION OF THE PREFERRED EMBODIMENT

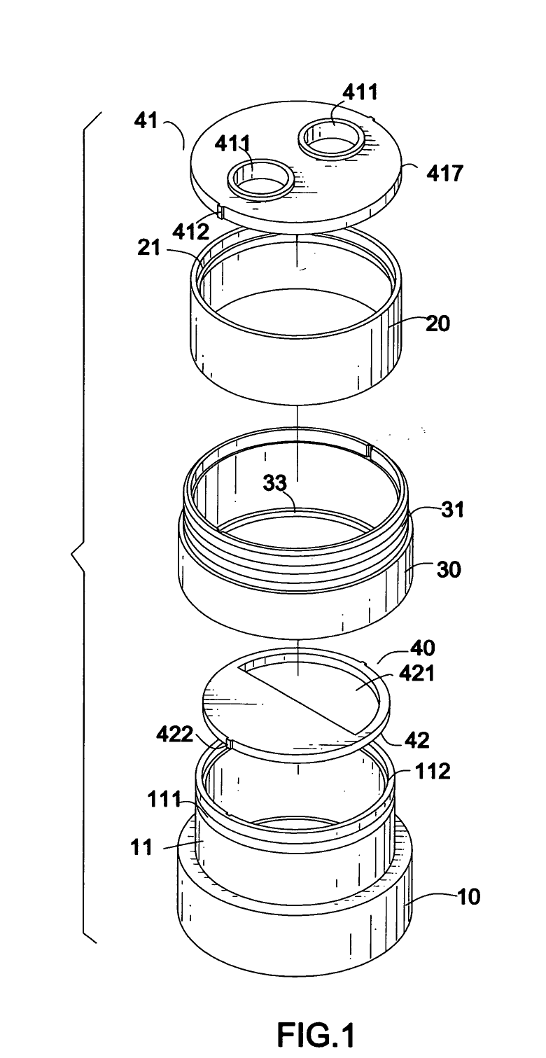

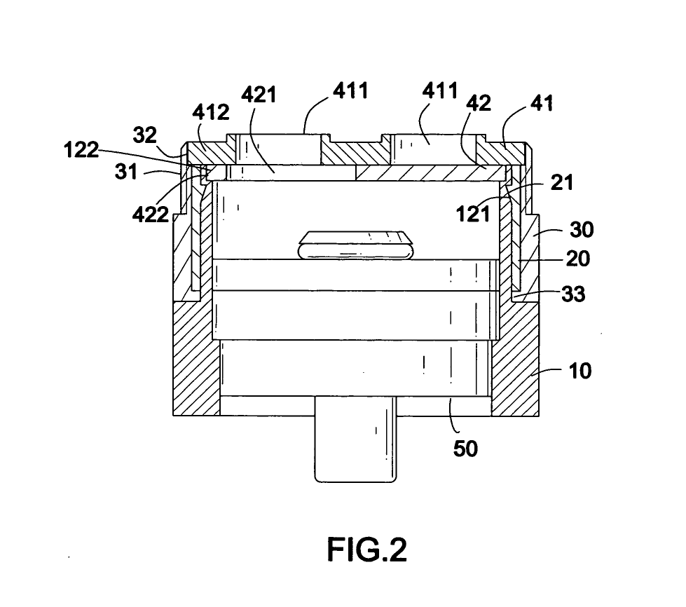

With reference to FIGS. 1-2, a control valve in accordance with the present invention is composed of a lower tube (10), a middle tube (20), an upper tube (30), and an outlet member (40).

The lower tube (10) has a neck (11) formed at a top end of the lower tube (10) with an outer diameter smaller than an outer diameter of a bottom end of the lower tube (10). An outer ring recess (111) is defined at an outer periphery of the neck (11), and a first inner ring recess (112) with an inner surface is defined at an inner wall of the neck (11). Two cutouts (not numbered) are defined in the inner surface of the first inner ring recesses (112).

The middle tube (20) is provided outside the neck (11), and a first ring (21) is formed at an inner wall of the middle tube (20) and positioned in the outer ring recess (111).

The upper tube (30) is provided outside the middle tube (20), and a threaded portion (31) is formed at an outer periphery thereof. A second inner ring recess (32) with an inner surface is defined at an inner wall of the upper tube (30). A second ring (33) is formed at an inner wall of the upper tube (30) for supporting the middle tube (20). The upper tube (30) has two cutouts (not numbered) defined in the second inner ring recess (32).

The outlet member (40) has an outlet disk (41) with two holes (411) defined through the outlet disk (41). Two first bosses (412) are formed at two diametrically opposite sides of the outlet disk (41) to correspond to the cutouts in the upper tube (30). The outlet disk (41) is positioned in the second inner ring recess (32) by the two first bosses (412) engaged in the cutouts and is immovable about the upper tube (30). An adjusting disk (42) is mounted in the lower tube (10) and abuts a bottom of the outlet disk (41). A semi-circular opening (421) is defined through a half of the adjusting disk (42). Two second bosses (422) are formed at two diametrically opposite sides of the adjusting disk (42) to correspond to the cutouts in the neck (11). By the two second bosses (422) engaged in the cutouts of the neck (11), the adjusting disk (42) is positioned in the first inner ring recess (112) and immovable about the lower tube (10).

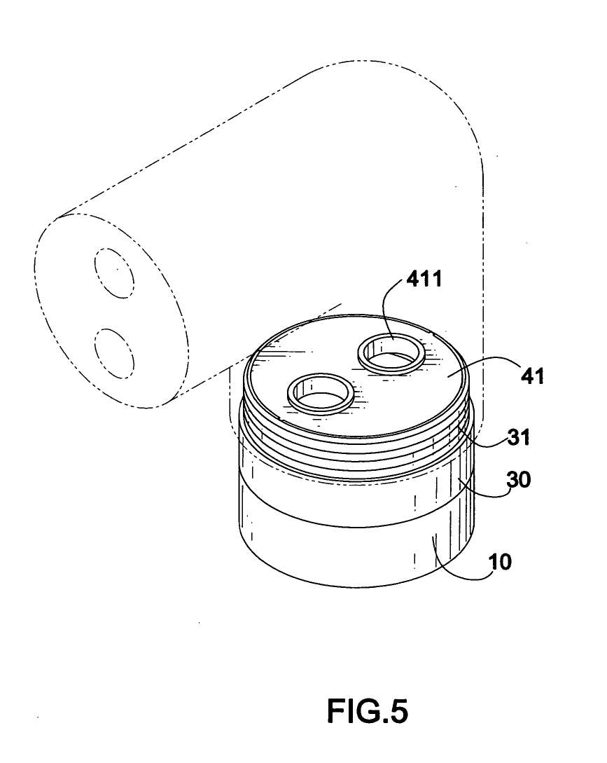

As illustrated in FIGS. 2 and 5, in assembly, a valve core (50) is mounted in the lower tube (10). The upper tube (30) is mounted outside an upper portion of the lower tube (10), and the middle tube (20) is mounted between the lower tube (10) and the upper tube (30) by engaging the first ring (21) in the outer ring recess (111) of the neck (11). Therefore, the lower tube (10) is rotatable about the middle tube (20). The adjusting disk (42) is secured in the first inner ring recess (112) of the neck (11) by the second bosses (422), and the outlet disk (41) is secured in the second inner ring recess (32) of the outer tube (30) by the first bosses (412). The upper tube (30) is threadingly mounted on an outlet pipe (not numbered) of a faucet (not shown), and the holes (411) are respectively in communication with a hot water conduit and a cold water conduit.

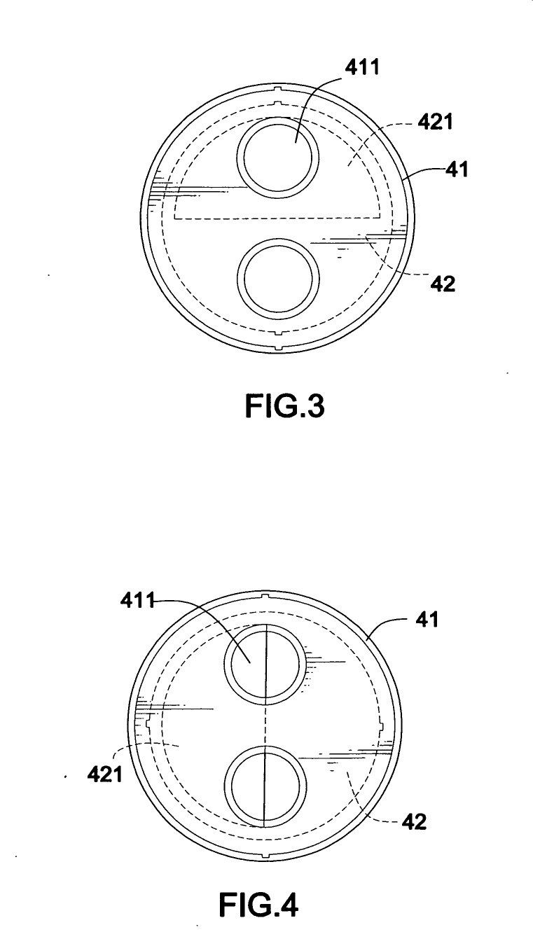

When a user turns the lower tube (10), the adjusting disk (42) is rotated along with the lower tube (10). In a status as shown in FIG. 3, the semi-circular opening (421) is completely located under one of the holes (411), so water in communication with this hole (411) can flow out, and the conduit in communication with the other hole (411) is blocked. In a status as shown in FIG. 4, the semi-circular opening (421) is in communication with the holes (411) at the same time, and hot and cold water can flow out through the opening (421). Therefore, a user can turn the lower tube to adjust hot and cold water in an appropriate ratio to achieve a mixture that has a desired temperature.

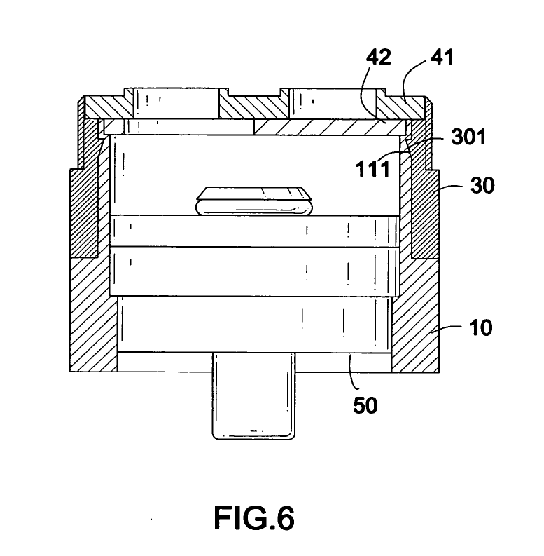

With reference to FIG. 6, in another embodiment of the present invention, the middle tube is eliminated, and the upper tube (301), combining the upper tube (30) includes a ring (301) formed at an inner wall thereof and positioned in the outer ring recess (111) of the neck (11).

Therefore, according to the present invention, the control valve is directly installed at an outlet of a faucet or a shower, and a user can conveniently adjust a water temperature by turning the lower tube of the control valve.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A control valve comprising:
a lower tube (10);
an upper tube (30) rotatably mounted outside an upper portion of the lower tube (10);
an outlet disk (41) immovably mounted in the upper tube (30), the outlet disk (41) having two holes (411) defined through the outlet disk (41);
an adjusting disk (42) immovably mounted in the lower tube (10) and abutting a bottom of the outlet disk (41), the adjusting disk (42) having an opening (421) defined through the adjusting disk, and
a valve core (50) installed in the lower tube (10).

2. The control valve as claimed in claim 1, wherein the lower tube (10) has an outer ring recess (111) defined at an outer periphery of the lower tube (10), and the upper tube (30) has a ring (301) formed at an inner wall of the upper tube (30) and positioned in the outer ring recess (111).

3. The control valve as claimed in claim 1 further comprising a middle tube (20) provided between the lower tube (10) and the upper tube (30), wherein the lower tube (10) has an outer ring recess (111) defined at an outer periphery of the lower tube (10), the middle tube (20) has a first ring (21) formed at an inner of the middle tube (20) and positioned in the outer ring recess (111) of the lower tube (10), and the upper tube (30) has a second ring (33) formed at an inner wall of the upper tube (30) for supporting the middle tube (20).

4. The control valve as claimed in claim 1, wherein the upper tube (30) has a threaded portion (31) formed at an outer periphery of the upper tube (30).

5. The control valve as claimed in claim 2, wherein the lower tube (10) has a neck (11) formed at a top end of the lower tube (10) with an outer diameter smaller than an outer diameter of a bottom end of the lower tube (10), and the outer ring recess (111) is defined at an outer periphery of the neck (11).

6. The control valve as claimed in claim 5, wherein the outer ring recess (111) is defined at an outer periphery of the neck (11), a first inner ring recess (112) is defined at an inner wall of the neck (11), and the adjusting disk (42) is positioned in the first inner ring recess (112).

7. The control valve as claimed in claim 6, wherein a second inner ring recess (32) is defined at an inner wall of the upper tube (30), and the outlet disk (41) is positioned in the second inner ring recess (32).

8. The control valve as claimed in claim 7, wherein the upper tube (30) has two first cutouts defined in an inner surface of the second inner ring recess (32), and the outlet disk (41) has two first bosses (412) formed at an outer periphery of the outlet disk (41) to correspond to the two first cutouts; the lower tube (10) has two second cutouts defined in an inner surface of the first inner ring recess (112), and the adjusting disk (42) has two second bosses (422) formed at an outer periphery of the adjusting disk (42) to correspond to the two second cutouts.

9. The control valve as claimed in claim 3, wherein the lower tube (10) has a neck (11) formed at a top end of the lower tube (10) with an outer diameter smaller than an outer diameter of a bottom end of the lower tube (10), and the outer ring recess (111) is defined at an outer periphery of the neck (11).

10. The control valve as claimed in claim 9, wherein the outer ring recess (111) is defined at an outer periphery of the neck (11), a first inner ring recess (112) is defined at an inner wall of the neck (11), and the adjusting disk (42) is positioned in the first inner ring recess (112).

11. The control valve as claimed in claim 10, wherein a second inner ring recess (32) is defined at an inner wall of the upper tube (30), and the outlet disk (41) is positioned in the second inner ring recess (32).

12. The control valve as claimed in claim 11, wherein the upper tube (30) has two first cutouts defined in an inner surface of the second inner ring recess (32), and the outlet disk (41) has two first bosses (412) formed at an outer periphery of the outlet disk (41) to correspond to the two first cutouts; the lower tube (10) has two second cutouts defined in an inner surface of the first inner ring recess (112), and the adjusting disk (42) has two second bosses (422) formed at an outer periphery of the adjusting disk (42) to correspond to the two second cutouts.

13. The control valve as claimed in claim 1, wherein the opening (421) of the adjusting disk (42) has a semi-circular shape.
